(19) United States
(12) Patent Application Publication
(10) Pub. No.: US 2025/0076707 A1
(43) Pub. Date: Mar. 6, 2025

(54) LIGHT SOURCE APPARATUS AND HEAD-UP DISPLAY

(71) Applicant: KOITO MANUFACTURING CO., LTD., Tokyo (JP)

(72) Inventor: Takanobu TOYOSHIMA, Shizuoka (JP)

(21) Appl. No.: 18/723,904

(22) PCT Filed: Feb. 1, 2023
(86) PCT No.: PCT/JP2023/003138

§ 371 Date: Jun. 25, 2024

(30) Foreign Application Priority Data
Feb. 14, 2022 (JP) 2022-020880

(51) Int. Cl. G02F 1/1335

(52) U.S. Cl. CPC G02F 1/133607

(57) ABSTRACT

To provide a light source apparatus and a head-up display which can be downsized and achieve uniform illumination. The light source apparatus includes a first light source (11) and a second light source (12), an irradiation portion (14, 15) irradiated with first emitted light from the first light source (11) and second emitted light from the second light source (12), and at least one of a condenser arranged between the first light source (11) and the irradiation portion (14, 15) to condense the first emitted light or a diffuser (D1) arranged between the second light source (12) and the irradiation portion (14, 15) to diffuse the second emitted light.

### TECHNICAL FIELD

The present invention relates to a light source apparatus and a head-up display.

### BACKGROUND ART

As one field of a light source apparatus, there is a light source apparatus as a so-called backlight that illuminates a liquid crystal display from the back. As a document disclosing such a light source apparatus, for example, Patent Literature 1 has been known.

The light source apparatus disclosed in Patent Literature 1 is a light source apparatus that illuminates a liquid crystal display used for a head-up display (hereinafter, “HUD”) from the back, which includes a light source in which a plurality of first light source elements that emit white light and a plurality of second light source elements that emit red light are arranged side by side in a predetermined direction, a first lens that converts light emitted from the light source unit into parallel light, and a second lens that deflects light emitted from the first lens so as to emit the light to a diffusion plate as an illumination area provided on the back surface of the liquid crystal display.

In Patent Literature 1, according to the light source apparatus having the above-described configuration, illumination is performed, using the first lens, such that light emitted from the plurality of light source elements having two different emission colors overlap with each other in a predetermined area on the incident surface of the liquid crystal display, so that a specific color can be efficiently displayed with high luminance in an image displayed on the liquid crystal display.

### CITATION LIST

### Patent Literature

Patent Literature 1: JP-A-2019-164285

### SUMMARY OF INVENTION

### Problems to be Solved by Invention

Incidentally, a light source apparatus for a liquid crystal display has been required to ensure particularly necessary luminance (generally relatively high luminance) and to have an ability to uniformly illuminate the entire liquid crystal display. Here, the uniform illumination refers to illumination in which not only illumination unevenness but also color unevenness is suppressed. In the case of use in, e.g., the HUD, the light source apparatus is also required to be further downsized in terms of installation space.

In this regard, the light source apparatus according to Patent Literature 1 also aims to increase luminance. However, in the light source apparatus according to Patent Literature 1, the light emitted from each of the first light source elements and the light emitted from each of the second light source elements are configured to illuminate the entire illumination area relatively uniformly. Thus, due to a limitation on an optical system, it is difficult to shorten a distance between the light source element and the first lens, a distance between the first lens and the second lens, and a distance between the second lens and an illumination target object. As a result, the light source apparatus according to Patent Literature 1 has a limit in downsizing. In addition, in the configuration of the light source apparatus according to Patent Literature 1, a light flux utilization efficiency tends to decrease.

For these reasons, the present invention has been made in view of the above-described conventional problems, and an object of the present invention is to provide a light source apparatus and a head-up display which can be downsized and achieve uniform illumination.

### Solution to Problems

In order to solve the above-described problems, the light source apparatus of the present invention includes a first light source and a second light source, an irradiation portion irradiated with first emitted light from the first light source and second emitted light from the second light source, and at least one of a condenser arranged between the first light source and the irradiation portion to condense the first emitted light or a diffuser arranged between the second light source and the irradiation portion to diffuse the second emitted light.

In such a light source apparatus of the present invention, light fluxes corresponding to the first light source and the second light source can be controlled by at least one of the condenser that condenses the first emitted light or the diffuser that diffuses the second emitted light, so that an object can be uniformly irradiated with illumination light.

In one aspect of the present invention, the light source apparatus further includes a light shield provided around at least one of the condenser or the diffuser.

In one aspect of the present invention, the light source apparatus further includes a light scatterer provided around the diffuser.

In one aspect of the present invention, the colors of the first light source and the second light source are different.

In one aspect of the present invention, the irradiation portion includes a first optical unit that controls the first emitted light and the second emitted light, or includes the first optical unit and a second optical unit arranged between the first optical unit and an object to control light emitted from the first optical unit.

In order to solve the above-described problems, the head-up display of the present invention includes any of the above-described light source apparatuses and a projector that projects light emitted from the light source apparatus.

### Effects of Invention

The present invention can provide the light source apparatus and the head-up display which can be downsized and achieve uniform illumination.

### BRIEF DESCRIPTION OF DRAWINGS

FIG. 1(a) is a schematic sectional view showing one example of the configuration of a light source apparatus according to a first embodiment, FIG. 1(b) is a schematic plan view showing illumination patterns by first light emitting elements in an illumination area, and FIG. 1(c) is a schematic plan view showing illumination patterns by second light emitting elements in the illumination area;

FIG. 2 is a schematic sectional view showing one example of a light source apparatus according to a modification of the first embodiment;

FIG. 3 is a schematic sectional view showing one example of the configuration of a light source apparatus according to a second embodiment;

FIG. 4 is a schematic sectional view showing one example of the configuration of a light source apparatus according to a third embodiment;

FIGS. 5(a) and 5(b) are schematic sectional views showing one example of the configuration of a light source apparatus according to a fourth embodiment; and

FIGS. 6(a) to 6(c) are schematic sectional views showing one example of the configuration of a light source apparatus according to a fifth embodiment.

### DESCRIPTION OF EMBODIMENTS

Hereinafter, embodiments of the present invention will be described in detail with reference to the drawings. The same or equivalent components, members, and processes shown in the drawings are denoted by the same reference numerals, and overlap description thereof will be omitted as necessary. In the following description, a form in which a light source apparatus according to the present invention is applied to a light source apparatus that illuminates a liquid crystal display used in an HUD from the back will be described as an example.

### First Embodiment

### <Light Source Apparatus>

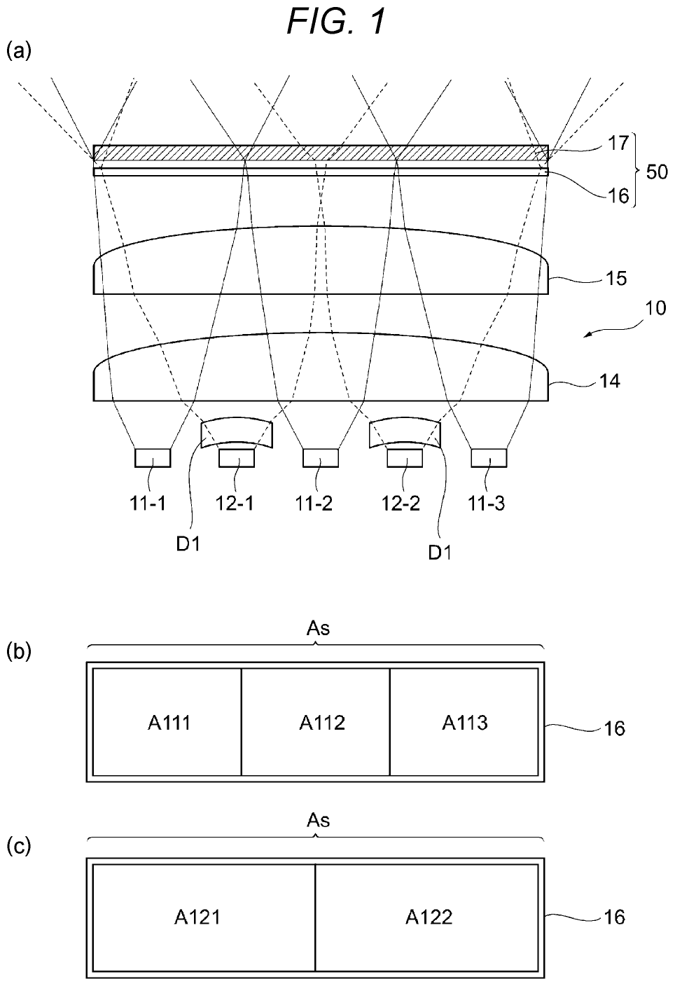

A light source apparatus 10 according to the present embodiment will be described with reference to FIG. 1. As shown in FIG. 1(a), the light source apparatus 10 includes first light emitting elements 11-1, 11-2, and 11-3 (hereinafter collectively referred to as a “first light emitting element(s) 11”), second light emitting elements 12-1, 12-2 (hereinafter collectively referred to as a “second light emitting element(s) 12”), a first lens 14, a second lens 15, and a diffuser D1. FIG. 1 also shows a liquid crystal display as one example of an object 50 to be illuminated, and the object 50 (liquid crystal display) includes a liquid crystal display 17 and a diffusion sheet 16.

The liquid crystal display 17 is a transmissive spatial modulation element that receives a modulation signal and spatially modulates irradiation light, and displays an image corresponding to the modulation signal. The diffusion sheet 16 functions to diffuse highly directional light deflected by the first lens 14 and the second lens 15, emit the diffused light to the liquid crystal display 17, and illuminate the liquid crystal display 17 more uniformly.

The first light emitting elements 11 are semiconductor light emitting elements such as a light emitting diode (LED), and are arranged in a predetermined direction (in the example of FIG. 1, the lateral direction of the plane of the paper). The color of light emitted from the first light emitting element 11 is not particularly limited, but in the present embodiment, white light is used as one example. Note that in the present embodiment, the number of arrays of the first light emitting elements 11 is one, but may be two or more. The first light emitting element 11 is not limited to the LED, and may be, e.g., a semiconductor laser.

The second light emitting elements 12 are semiconductor light emitting elements such as an LED, and are alternately arranged between the first light emitting elements 11 and arranged in a predetermined direction (in the example of FIG. 1, the lateral direction of the plane of the paper). The color of light emitted from the second light emitting element 12 is not particularly limited, but in the present embodiment, blue light is used as one example. That is, in the present embodiment, the liquid crystal display 17 is basically illuminated with white light from the first light emitting element 11, and blue light from the second light emitting element 12 is added as a correction color. The correction color is used, for example, for a reason of reinforcing a color having low transmittance in the liquid crystal display 17 which is part of the object 50. Note that the reason for using the correction color is not limited thereto and the correction color may be used for various reasons such as use of a synthesized color and adjustment of a color tone.

Note that in the present embodiment, the number of arrays of the second light emitting elements 12 is one, but may be two or more according to the number of first light emitting elements 11. The second light emitting element 12 is not limited to the LED, and may be, e.g., a semiconductor laser. The “first light emitting element 11” and the “second light emitting element 12” are examples of a “first light source” and a “second light source” according to the present invention.

The first lens 14 and the second lens 15 have a function of guiding, in combination, light emitted from the first light emitting elements 11 and the second light emitting elements 12 to an illumination area As (see FIGS. 1(b) and 1(c)) of the object 50. In the present embodiment, the illumination area As is the back surface (surface closer to the first light emitting element 11 and the second light emitting element 12) of the diffusion sheet 16 as one example. However, where to set the illumination area As may be determined in consideration of, e.g., the specifications of the light source apparatus, and may be, for example, the back surface of the liquid crystal display 17. In the following description, the first lens 14 and the second lens 15 may be referred to as a “first common lens” and a “second common lens.”

The first lens 14 has a function of condensing light emitted from the first light emitting elements 11 and the second light emitting elements 12 each having a relatively great directional angle (angle at which light emitted from the LED spreads) and emitting the light as, for example, parallel light or a light flux close to parallel light (hereinafter, both will be collectively referred to as “substantially parallel light”). The shape of the first lens 14 is not particularly limited as long as the first lens 14 is a lens having positive power, for example. Note that the positive and negative of the power of the first lens 14 should be determined by, e.g., the directional angle of light emitted from the first light emitting element 11 and the second light emitting element 12, and the power is not limited to one of the positive or the negative. In the present embodiment, a plano-convex lens is used as one example of the first lens 14.

The second lens 15 controls the light flux such that, for example, the substantially parallel light emitted from the first lens 14 uniformly illuminates the entire illumination area As. Thus, the shape of the second lens 15 and the positive and negative of the power thereof are selected according to this purpose, but in the present embodiment, a plano-convex lens is used as one example of the second lens 15. Here, in the present embodiment, a form in which the second lens 15 is arranged in addition to the first lens 14 will be described as an example, but the second lens 15 may be omitted in a case where divided illumination described later can be performed only with the first lens 14. Note that the “first lens 14” and the “second lens 15” are examples of a “first optical unit” and a “second optical unit” according to the present invention. In addition, the “first lens 14” alone or the “first lens 14” and the “second lens 15” are one example of an “irradiation portion” according to the present invention. The first lens 14 and the second lens 15 are made of, for example, resin such as acrylic resin or glass.

The diffuser D1 is provided between each of the second light emitting elements 12-1, 12-2 and the first lens 14. The diffuser D1 has a function of diffusing light emitted from the second light emitting element 12. Details of the diffuser D1 will be described later.

As described above, a light source apparatus for a liquid crystal display has been required to have high luminance and a uniform illumination ability and to be downsized. Thus, in the present embodiment, the entire illumination area As is dividedly illuminated (hereinafter “divided illumination”) in three illumination patterns by first emitted light from each of the three first light emitting elements 11, and is dividedly illuminated in two illumination patterns by second emitted light from each of the two second light emitting elements 12.

The divided illumination will be described in more detail with reference to FIGS. 1(b) and 1(c). FIG. 1(b) shows one example of the illumination pattern (divided illumination) by the first light emitting elements 11, and FIG. 1(c) shows one example of the illumination pattern (divided illumination) by the second light emitting elements 12. FIGS. 1(b) and 1(c) show the illumination pattern on the back surface of the diffusion sheet 16 as the illumination area As.

As shown in FIG. 1(b), the illumination area As is dividedly illuminated in three illumination patterns A111, A112, A113. That is, the illumination pattern A111 is the illumination pattern by the first light emitting element 11-1, the illumination pattern A112 is the illumination pattern by the first light emitting element 11-2, and the illumination pattern A113 is the illumination pattern by the first light emitting element 11-3. The illumination patterns A111, A112, A113 are laid without gaps, and as a whole, uniformly illuminate the illumination area As. Note that it is important that there are no gaps between the illumination patterns A111, A112, A113 and slight overlap is allowed. For example, defocus by position adjustment of the optical elements such as the first lens 14 and the second lens 15 may be used as a technique of allowing slight overlap and more reliably suppressing the gaps.

As shown in FIG. 1(c), the illumination area As is dividedly illuminated in two illumination patterns A121, A122. That is, the illumination pattern A121 is the illumination pattern by the second light emitting element 12-1, and the illumination pattern A122 is the illumination pattern by the second light emitting element 12-2. The illumination patterns A121, A122 are laid without gaps, and as a whole, uniformly illuminate the illumination area As. Note that it is important that there are no gaps between the illumination patterns A121, A122 and slight overlap is allowed. As described above, in the light source apparatus 10 according to the present embodiment, the illumination area As is illuminated by the illumination in which the divided illumination by the first light emitting elements 11 and the divided illumination by the second light emitting elements 12 are combined.

Here, when the divided illumination is employed as in the present embodiment, it is necessary to control the light flux emitted from the first light emitting elements 11 or the light flux emitted from the second light emitting elements 12. That is, in the present embodiment, the directional angle of light emitted from a light emission surface of the first light emitting element 11 is equal to the directional angle of light emitted from a light emission surface of the second light emitting element 12. Even if the first lens 14 and the second lens 15 are simply arranged in this state, it is not possible to perform optimum divided illumination by each of the first light emitting elements 11 and the second light emitting elements 12. This is because when the number of light emitting elements varies, the illumination pattern for the illumination area As varies, and for example, when the first lens 14 and the second lens 15 are arranged so as to form the illumination patterns of the first light emitting elements 11, gaps are formed between the illumination patterns of the second light emitting elements 12.

In order to cope with the above-described situation, the diffuser D1 is provided in the present embodiment. That is, the diffuser D1 provided above each of the light emission surfaces of the second light emitting elements 12-1, 12-2 acts to spread the light flux of light emitted from the second light emitting elements 12-1, 12-2 and fill the above-described gaps with the light. Accordingly, the illumination patterns A121, A122 for illuminating the entire illumination area As without the gaps as shown in FIG. 1(c) are obtained. As a result, according to the light source apparatus 10 of the present embodiment, it is possible to shorten at least one (hereinafter, may be referred to as an “optical length”) of a distance between each of the first light emitting element 11 and the second light emitting element 12 and the first lens 14, a distance between the first lens 14 and the second lens 15, and a distance between the second lens 15 and the object 50. That is, the length of the light source apparatus 10 in the longitudinal direction (direction in which light emitted from the first light emitting element 11 and the second light emitting element 12 travels) thereof is shortened, and the light source apparatus 10 is downsized. Which one of the distance between each of the first light emitting element 11 and the second light emitting element 12 and the first lens 14, the distance between the first lens 14 and the second lens 15, and the distance between the second lens 15 and the object 50 is shortened is selected according to, e.g., a specific design condition for the light source apparatus 10.

### <Head-Up Display>

Next, a head-up display according to the present embodiment will be described. In the head-up display (HUD) according to the present embodiment, an HUD unit is stored in, for example, a dashboard of a vehicle, and an image from the HUD unit is projected and displayed on, for example, a windshield of the vehicle. The HUD unit is a unit represented by a liquid crystal display and configured to reflect an image light source by a flat mirror and enlarge the image light source by, e.g., a concave mirror, and the generated image is reflected by the windshield and is guided to driver's eyes so that a driver can visually recognize the image.

The HUD according to the present embodiment includes the light source apparatus 10, the object 50 (liquid crystal display), and a projector (not shown). The projector includes, for example, the flat mirror, the concave mirror, and the windshield described above. An image is displayed by projecting light emitted from the object 50 by the projector. Since the head-up display according to the present embodiment uses the light source apparatus 10, the head-up display can be downsized and can generate an even image.

As described above in detail, according to the light source apparatus and the head-up display according to the present embodiment, it is possible to provide a light source apparatus and a head-up display which can be downsized and achieve uniform illumination.

### Modification of First Embodiment

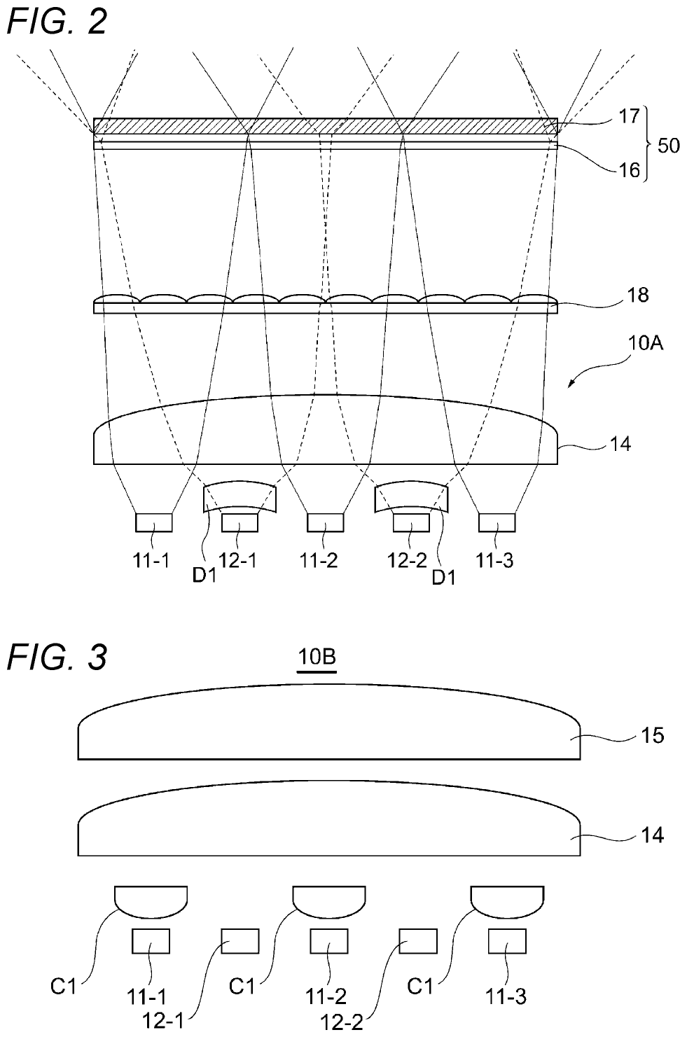

A light source apparatus 10A according to the present embodiment will be described with reference to FIG. 2. The light source apparatus 10A has a form in which the second lens 15 is replaced with a lens of another form in the light source apparatus 10 according to the above-described embodiment. Thus, other configurations are similar to those of the light source apparatus 10, and therefore, if necessary, refer to FIG. 1 and detailed description thereof will be omitted.

The first common lens may be selected in terms of a light flux shaping function, whereas the second common lens may be selected in terms of the uniformity of an illumination pattern and a light flux utilization efficiency rather than the light flux shaping function. From such a viewpoint, in the present embodiment, a lenticular lens 18 is used as the second lens. By using the lenticular lens 18, light beams are convoluted and diffused, so that the light beams can be mixed and the uniformity of the illumination pattern and the light flux utilization efficiency can be further improved. Further, the lenticular lens 18 can be formed thin. This contributes to further downsizing. Note that the second common lens used in the present embodiment is not limited to the lenticular lens 18 and, e.g., a Fresnel lens may be used. Also in this case, effects similar to those of the lenticular lens 18 can be obtained.

### Second Embodiment

A light source apparatus 10B according to the present embodiment will be described with reference to FIG. 3. The light source apparatus 10B has a form in which the diffuser D1 is replaced with a condenser C1 in the light source apparatus 10 according to the above-described embodiment. Thus, other configurations are similar to those of the light source apparatus 10, and therefore, if necessary, refer to FIG. 1 and detailed description thereof will be omitted.

As shown in FIG. 3, the light source apparatus 10B includes the condenser C1 above the light emission surface of the first light emitting element 11. In the light source apparatus 10, the light flux emitted from the second light emitting elements 12 is diffused by the diffusers D1, and the light emitted from each of the first light emitting elements 11 and the second light emitting elements 12 can form appropriate illumination patterns in the illumination area As. On the other hand, in the present embodiment, by condensing the light emitted from the first light emitting elements 11 without controlling the light flux of the light emitted from the second light emitting elements 12, the light emitted from each of the first light emitting elements 11 and the second light emitting elements 12 can form appropriate illumination patterns in the illumination area As.

More specifically, as one example, first, the first lens 14 and the second lens 15 are positioned such that the light emitted from the second light emitting elements 12-1, 12-2 forms the illumination patterns A121, A122 (see FIG. 1(c)). Then, the condensers C1 are selected and arranged such that the first light emitting elements 11-1, 11-2, and 11-3 form the illumination patterns A111, A112, A113 under this condition. This is because when the first lens 14 and the second lens 15 are optimally arranged with respect to the second light emitting elements 12, the overlap of the illumination patterns A111, A112, A113 from the first light emitting elements 11-1, 11-2, and 11-3 may be excessive.

As described above, according to the light source apparatus 10B of the present embodiment, it is also possible to provide a light source apparatus and a head-up display which can be downsized and achieve uniform illumination. Further, according to the above-described embodiments and the present embodiment, it is possible to flexibly select a control unit for the light fluxes from the first light emitting elements 11 and the second light emitting elements 12. In general, the condenser C1 is used for a greater number of light emitting elements out of the first light emitting elements 11 and the second light emitting elements 12, and the diffuser D1 is used for a smaller number of light emitting elements. Needless to say, any one of the condenser C1 or the diffuser D1 may be used. Which one of the diffuser D1 or the condenser C1 is used may be determined on the condition that, for example, a smaller number of diffusers D1 or the condensers C1 to be arranged is selected.

### Third Embodiment

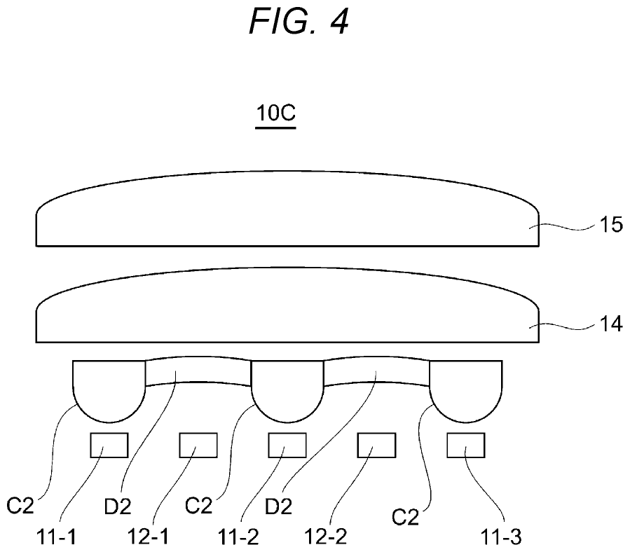

A light source apparatus 10C according to the present embodiment will be described with reference to FIG. 4. The light source apparatus 10C has a form in which the diffusers D1 and the condensers C1 are integrated in the light source apparatus 10, 10B according to the above-described embodiments. Thus, other configurations are similar to those of the light source apparatus 10, and therefore, if necessary, refer to FIG. 1 and detailed description thereof will be omitted.

As shown in FIG. 4, the light source apparatus 10C includes condensers C2 arranged above the light emission surfaces of the first light emitting elements 11 and diffusers D2 arranged above the light emission surfaces of the second light emitting elements 12. The functions of the condenser C2 and the diffuser D2 are as described above. Three condensers C2 are designed such that the first light emitting elements 11-1, 11-2, 11-3 form the illumination patterns A111, A112, A113 (see FIG. 1(b)), and two diffusers D2 are designed such that the second light emitting elements 12-1, 12-2 form the illumination patterns A121, A122 (see FIG. 1(c)).

In the light source apparatus 10C according to the present embodiment, as shown in FIG. 4, the three condensers C2 and the two diffusers D2 are integrally formed. An optical member in which the condensers C2 and the diffusers D2 are integrated can be produced by integral molding using, for example, resin. According to the light source apparatus 10C of the present embodiment, in addition to the effects of the light source apparatus 10, there is an effect of simplifying alignment of the optical members including the first light emitting elements 11, the second light emitting elements 12, the condensers C2, the diffusers D2, the first lens 14, and the second lens 15.

### Fourth Embodiment

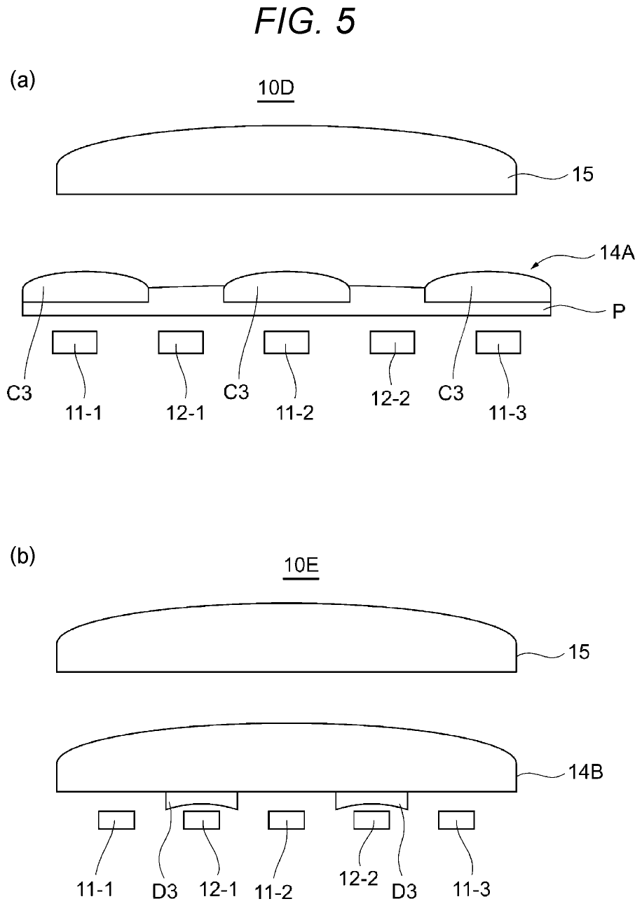

Light source apparatuses 10D, 10E according to the present embodiment will be described with reference to FIG. 5. The light source apparatus 10D, 10E has a form in which the diffusers D1 or the condensers C1 are integrated with the first lens 14 in the light source apparatus 10, 10B according to the above-described embodiments. Thus, other configurations are similar to those of the light source apparatus 10, and therefore, if necessary, refer to FIG. 1 and detailed description thereof will be omitted.

As shown in FIG. 5(a), the light source apparatus 10D includes a first lens 14A. In the first lens 14A, three condensers C3 are formed on a flat plate portion P, and each of the three condensers C3 has a plano-convex lens shape. Note that the shape of the condenser C3 is not limited to the plano-convex lens shape, and may be, for example, a convex lens shape. The three condensers C3 are each arranged above the light emission surfaces of the three first light emitting elements 11, and in combination with the action of the second lens 15, form the illumination patterns A111, A112, A113 (see FIG. 1(b)) in the illumination area As.

Contrary to the first light emitting element 11, the first lens 14A does not have a lens function in an area corresponding to the light emission surface of the second light emitting element 12. That is, light emitted from the second light emitting element 12 passes through the flat plate portion P, and forms the illumination patterns A121, A122 (see FIG. 1(c)) by the action of the second lens 15. According to the light source apparatus 10D, since the condensers C3 and the first common lens are integrated, the optical length can be further shortened.

As shown in FIG. 5(b), the light source apparatus 10E includes a first lens 14B. Two diffusers D3 are formed on an incident surface (surface closer to the second light emitting element 12) of the first lens 14B, and have downward concave lower surfaces and straight upper surfaces. The two diffusers D3 are each arranged above the light emission surfaces of the two second light emitting elements 12, and in combination with the action of the second lens 15, form the illumination patterns A121, A122 (see FIG. 1(c)) in the illumination area As.

Since the first light emitting element 11 directly faces the incident surface of the first lens 14B, light emitted from the first light emitting elements 11 forms the illumination patterns A111, A112, A113 (see FIG. 1(b)) by the action of the first lens 14B and the second lens 15 as plano-convex lenses. According to the light source apparatus 10E, since the diffusers D3 and the first common lens are integrated, the optical length can be further shortened.

As described above, according to the light source apparatuses 10D, 10E of the present embodiment, an effect of further downsizing the apparatus is provided in addition to the effects of the light source apparatus 10.

### Fifth Embodiment

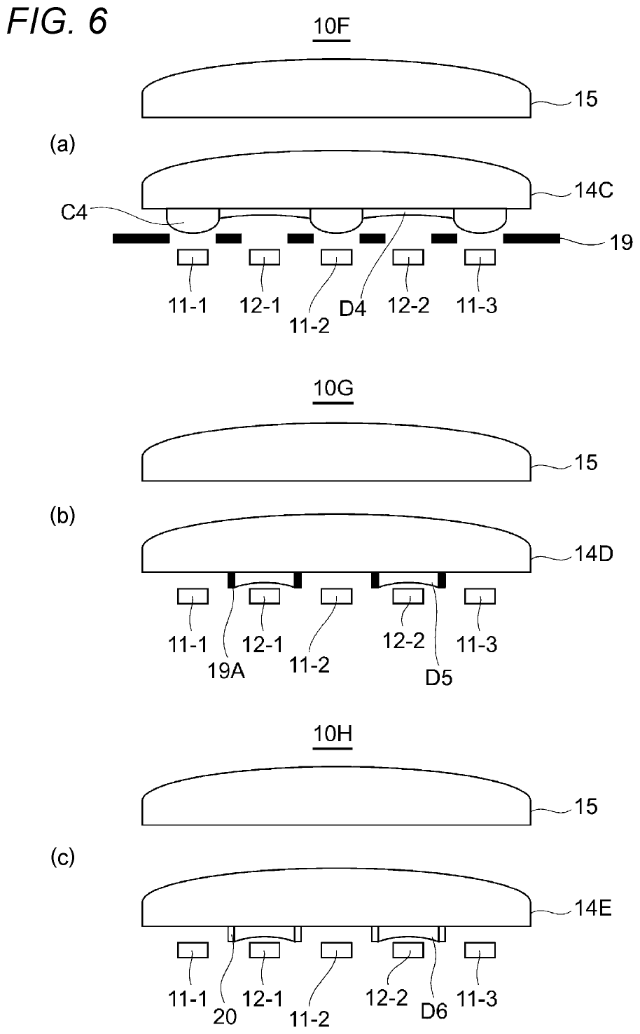

Light source apparatuses 10F, 10G, 10H according to the present embodiment will be described with reference to FIG. 6. The present embodiment has a form in which a light shield or a light scatterer is provided in the condenser or the diffuser in each of the above-described embodiments. Thus, other configurations are similar to those of the light source apparatus 10, and therefore, if necessary, refer to FIG. 1 and detailed description thereof will be omitted.

As shown in FIG. 6(a), the light source apparatus 10F includes a first lens 14C configured such that condensers C4 and diffusers D4 are integrated. The condenser C4 is arranged above the light emission surface of the first light emitting element 11, the diffuser D4 is arranged above the light emission surface of the second light emitting element 12, and the divided illumination shown in FIGS. 1(b) and 1(c) is performed by the action of the first lens 14C and the second lens 15.

Here, light emitted from the LED generally has a great directional angle, and for example, crosstalk is caused between adjacent LEDs and stray light may be caused due to such crosstalk. Since the stray light causes color unevenness and illumination unevenness in the illumination area As, it is necessary to suppress the stray light as much as possible. For this reason, in the light source apparatus 10F, a light shield 19 is provided to suppress the stray light. As shown in FIG. 6(a), the light shield 19 is arranged in the vicinity of both ends of each of the condensers C4 and the diffusers D4. Accordingly, light having a great directional angle and emitted from the first light emitting elements 11 and the second light emitting elements 12 is shielded. As a result, the light source apparatus 10F can more effectively suppress the color unevenness and the illumination unevenness in the illumination area As.

As shown in FIG. 6(b), the light source apparatus 10G includes a first lens 14D configured such that diffusers D5 are integrated. The diffuser D5 is arranged above the light emission surface of the second light emitting element 12, and the first light emitting element 11 directly faces the incident surface of the first lens 14D. The divided illumination shown in FIGS. 1(b) and 1(c) is performed by the action of the first lens 14D and the second lens 15.

In the light source apparatus 10G, a light shield 19A is formed around the diffuser D5. The light shield 19A has a function of suppressing the stray light as in the light shield 19. According to the light shield 19A, since the light shield 19A is integrated with the diffuser D5, alignment with, e.g., the diffuser D5 and the second light emitting element 12 is unnecessary and there is an effect of further facilitating assembly.

As shown in FIG. 6(c), the light source apparatus 10H includes a first lens 14E configured such that diffusers D6 are integrated. The diffuser D6 is arranged above the light emission surface of the second light emitting element 12, and the first light emitting element 11 directly faces the first lens 14E. The divided illumination shown in FIGS. 1(b) and 1(c) is performed by the action of the first lens 14E and the second lens 15.

In the light source apparatus 10H, a light scatterer 20 is formed around the diffuser D6. The light scatterer 20 is formed by, e.g., fine asperities, a rough surface, or embossment, and has an effect of scattering light having a great directional angle and having entered from the second light emitting element 12. That is, in the light source apparatus 10G, the stray light is shielded by the light shield 19A, but in the light source apparatus 10H, the stray light is scattered to suppress the influence of the stray light in the illumination patterns shown in FIGS. 1(b) and 1(c) and a uniform illumination pattern is realized. According to the light scatterer 20, there is an effect of further enhancing the light flux utilization efficiency. According to the light scatterer 20, since the light scatterer 20 is integrated with the diffuser D6, alignment with, e.g., the diffuser D6 and the second light emitting element 12 is unnecessary and there is an effect of further facilitating assembly.

As described above, according to the light source apparatuses 10F, 10G, 10H of the present embodiment, in addition to the effects of the light source apparatus 10, an effect of more effectively suppressing the color unevenness and the illumination unevenness in the illumination area As is further obtained.

Here, in the present embodiment, the form in which the light shield or the light scatterer is provided has been described as an example, but the present invention is not limited thereto and both may be used in combination. That is, for example, the light shield may be provided on the first light emitting element 11 side, and the light scatterer may be provided on the second light emitting element 12 side.

In addition, the technique of suppressing the stray light is not limited to above, and for example, there is a technique of applying a light absorbing material to part of the optical component (condenser, diffuser, first common lens, second common lens, etc.) or a technique of making the shape of the incident surface of the optical component as continuous and smooth as possible.

Note that in the present embodiment, the form in which the number of first light emitting elements 11 is three and the number of second light emitting elements 12 is two has been described as an example, but the number of each type of light emitting element is not limited thereto and both may be one or more.

In each of the above-described embodiments, the form in which the diffuser and the condenser are arranged as part of the optical system has been described as an example, but the present invention is not limited thereto and, for example, a form in which the diffuser and the condenser are formed on the light emission surface of the light emitting element may be employed.

In each of the above-described embodiments, e.g., the arrangements of the condenser, the diffuser, the light shield, the light scatterer, etc. have been separately described, but may be appropriately combined.

The present international application claims priority based on Japanese Patent Application No. 2022-020880 filed on Feb. 14, 2022, and the entire contents of Japanese Patent Application No. 2022-020880 are incorporated herein by reference.

The description of the specific embodiments of the present invention is presented for the purpose of illustration. The specific embodiments are not intended to be exhaustive or to limit the invention as it is in the form described. It is obvious to those skilled in the art that many modifications and alterations are possible in light of the contents of the description above.

### LIST OF REFERENCE SIGNS

10, 10A, 10B, 10C, 10D, 10E, 10F, 10G, 10H Light source apparatus
11, 11-1, 11-2, 11-3 First light emitting element
12, 12-1, 12-2 Second light emitting element
14, 14A, 14B, 14C, 14D, 14E First lens
15 Second lens
16 Diffusion sheet
17 Liquid crystal display
18 Lenticular lens
19, 19A Light shield
20 Light scatterer
50 Object
As Illumination area
C1, C2, C3, C4 Condenser
D1, D2, D3, D4, D5, D6 Diffuser
P Flat plate portion

1. A light source apparatus comprising:
a first light source and a second light source;
an irradiation portion irradiated with first emitted light from the first light source and second emitted light from the second light source; and
at least one of a condenser arranged between the first light source and the irradiation portion to condense the first emitted light or a diffuser arranged between the second light source and the irradiation portion to diffuse the second emitted light.

2. The light source apparatus according to claim 1, further comprising:
a light shield provided around at least one of the condenser or the diffuser.

3. The light source apparatus according to claim 1, further comprising:
a light scatterer provided around the diffuser.

4. The light source apparatus according to claim 1, wherein
colors of the first light source and the second light source are different.

5. The light source apparatus according to claim 1, wherein
the irradiation portion includes a first optical unit that controls the first emitted light and the second emitted light, or includes the first optical unit and a second optical unit arranged between the first optical unit and an object to control light emitted from the first optical unit.

6. A head-up display comprising:
the light source apparatus according to claim 1; and
a projector that projects light emitted from the light source apparatus.
